(19) United States
(12) Patent Application Publication
(10) Pub. No.: US 2004/0166910 A1
(43) Pub. Date: Aug. 26, 2004

(54) Case for cellular phone

(76) Inventors: Myung Sub Ha, Busan (KR); Kenji Hidaka, Fukuoka (JP)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(21) Appl. No.: 10/373,976

(22) Filed: Feb. 25, 2003

(51) Int. Cl. H04B 1/00

(52) U.S. Cl. 455/575.8

(57) ABSTRACT

A case for a cellular phone in which an elastic member having corrugated protrusions is attached to inner side of the case. The corrugated protrusions are formed on one or both inner sides of the case facing each other. The corrugated protrusions are formed vertically or horizontally with respect to a direction in which the cellular phone is inserted. Thus, an external impact is absorbed. Also, the cellular phone does not easily slip out without an additional locking apparatus so that a possibility of losing is low. Further, when the surface of the cellular phone is contaminated, the surface of the cellular phone is cleaned by simple actions of inserting and taking out the cellular phone with respect to the case.

### BACKGROUND OF THE INVENTION

1. Field of the Invention

The present invention relates to a case for a cellular phone, and more particularly, to a case for a cellular phone in which an elastic member having corrugated protrusions is attached to an inner side of the case, in which the corrugated protrusions are formed on one or both inner sides of the case facing each other and also vertically or horizontally with respect to a direction in which the cellular phone is inserted.

2. Description of the Related Art

In general, a case for a cellular phone is made of leather or vinyl so that an external impact is directly transferred to the cellular phone. Also, a conventional cellular phone needs a cover and a locking device for fear of loss. Accordingly, without the cover or additional locking device, the cellular phone can easily slip out and lost. Since no special function to treat contamination of a surface of the cellular phone is provided, a user needs to clean the surface of the cellular phone.

### SUMMARY OF THE INVENTION

To solve the above and other problems, the present invention provides a case for a cellular phone which can absorb an external impact.

Also, the present invention provides a case for a cellular phone which prevents the cellular phone from slipping out of the case without an additional locking device so that a possibility of losing the cellular phone is low.

According to an aspect of the present invention, a case for a cellular phone comprises an elastic member having corrugated protrusions which is attached to an inner side of the case.

The corrugated protrusions are formed on both inner sides of the case facing each other.

The corrugated protrusions are formed vertically with respect to a direction in which the cellular phone is inserted.

The corrugated protrusions are formed horizontally with respect to a direction in which the cellular phone is inserted.

The corrugated protrusions are formed vertically with respect to a direction in which the cellular phone is inserted, and corrugated grooves are formed horizontally at an interval corresponding to a distance between two pitches of the corrugated protrusions.

The corrugated protrusions are formed in sawtooth form with respect to the direction in which the cellular phone is inserted, so that the cellular phone is easily inserted but does not easily slip out.

The elastic member is made of EVA (ethylene vinyl acetate). The elastic member is made of PU (polyurethane). The elastic member is sponge.

### BRIEF DESCRIPTION OF THE DRAWINGS

The above features of the present invention will become more apparent by describing in detail preferred embodiments thereof with reference to the attached drawings in which:

FIG. 1 is a perspective view illustrating a case of a cellular phone according to a preferred embodiment of the present invention;

FIG. 2 is a perspective view illustrating a case of a cellular phone according to another preferred embodiment of the present invention;

FIG. 3 is a perspective view illustrating a case of a cellular phone according to a yet another preferred embodiment of the present invention;

FIG. 4 is a perspective view illustrating a case of a cellular phone according to a yet further another preferred embodiment of the present invention; and

FIG. 5 is a perspective view illustrating a case of a cellular phone according to a still yet further another preferred embodiment of the present invention.

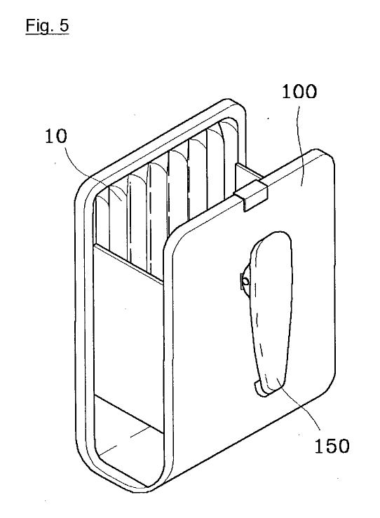

### DETAILED DESCRIPTION OF THE INVENTION

Referring to the drawings, the present invention concerns an elastic member 10 having corrugated protrusions and attached to an inner side of a case 100 for a cellular phone. The elastic member is preferably made of a foaming material such as EVA (ethylene vinyl acetate) or PU (polyurethane).

A property of EVA is determined by a degree of polymerization and a content of vinyl acetate. As the molecular weight of EVA increases, strength, plasticity, anti-stress cracking, and impact resistance are improved. When EVA is formed as a foaming body, it becomes a fine foaming body, is light, and exhibit a superior anti-abrasion.

PU is a generic term for a highly polymerized compound of urethane combination and is made by the combination of an alcohol radical and an isocyanic acid radical. In the present invention, urethane foam in which foams are included in polyurethane is mainly used.

A typical foaming elastic member made of the above material is sponge. However, the technical concept of the present invention is not limited to the above description and a conventional elastic member such as rubber can be used therefor.

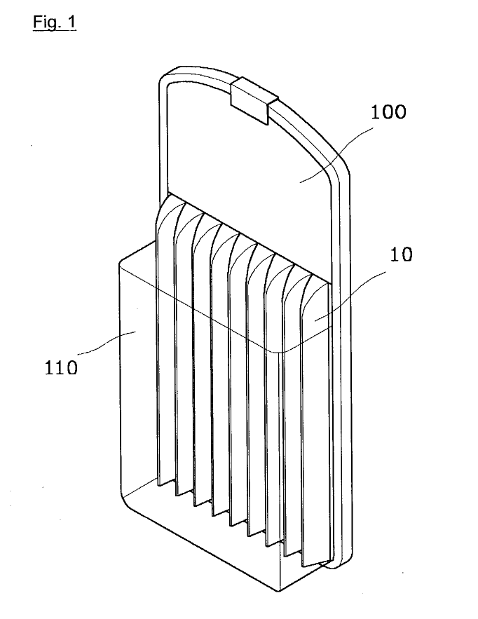

Referring to FIG. 1, the elastic member 10 having corrugated protrusions is attached to the inner side of the case 100 for a cellular phone so that the cellular phone can be protected from an external impact.

The corrugated protrusions maintain their original shapes before the cellular phone is inserted. However, when the cellular phone is inserted, the corrugated protrusions are compressed and press the cellular phone not to escape from the case 100.

The corrugated protrusions can be formed on both side surfaces facing each other in the case 100 for a cellular phone or on one side surface thereof. When the corrugated protrusions are formed on both side surfaces of the case 100, a pressing function is improved. When one side surface of the case 100 is formed of transparent vinyl 110 considering the outer appearance of the cellular phone, the corrugated protrusions can be formed only on the other side surface. Due to the pressing function, the cellular phone according to the present invention characteristically does not need a cover.

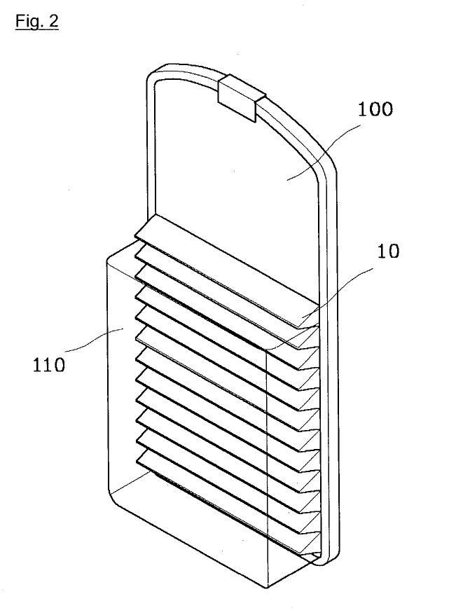

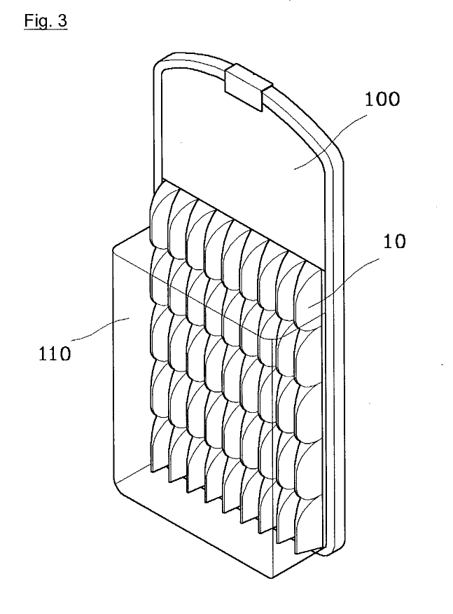

The corrugated protrusions are formed vertically or horizontally with respect to a direction in which the cellular phone is inserted. As shown in FIGS. 1 and 2, when the corrugated protrusions are formed vertically, the cellular phone is easily inserted or taken out. As shown in FIG. 3, when the corrugated protrusions are formed horizontally, fine dust adhering to the surface of the cellular phone can be removed as the cellular phone is inserted or taken out.

In general, the surface or a display window of the cellular phone is naturally contaminated by dust or sweat when the cellular phone is carried. When the case 100 for a cellular phone according to the present invention is used, by simply inserting in or taking out the cellular phone, the corrugated protrusions formed in a horizontal direction clean the surface of the cellular phone so that stains by dust or sweat are removed, providing a fresh sense during use of the cellular phone.

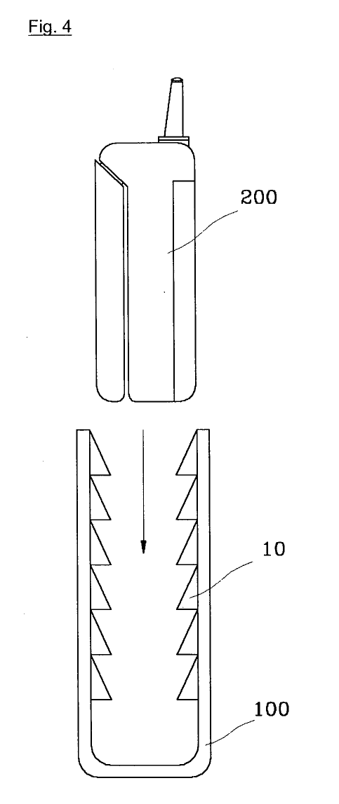

As shown in FIG. 4, the corrugated protrusions are formed vertically with respect to a direction in which the cellular phone is inserted or taken out, while corrugated grooves are formed horizontally at an interval corresponding to a distance between two pitches in the corrugate protrusions. Thus, the cellular phone is easily inserted or taken out and simultaneously a cleaning function is provided.

In the present invention, the direction in which the corrugated protrusions are formed is not limited to the aboveOdescribed preferred embodiment. The corrugated protrusions are formed horizontally with respect to the direction in which the cellular phone is inserted or taken out, while corrugated grooves are formed vertically at an interval corresponding to a distance between two pitches in the corrugate protrusions. Thus, the cellular phone is easily inserted or taken out and simultaneously a cleaning function is provided.

The present invention is characteristic in that, as shown in FIG. 4, the corrugated protrusions are formed as sawtoothed protrusions each having a reverse triangular shape in a direction in which the cellular phone 200 is inserted. Thus, the cellular phone can be easily inserted but not easily slip out.

The reverse triangular sawtoothed protrusions are preferably formed in a predetermined direction so that the cellular phone does not easily slip out. Accordingly, when the cellular phone is to be inserted, the elastic member 10 is thinly compressed so as to facilitate insertion of the cellular phone. When the cellular phone is to be taken out, the elastic member 10 is thickly compressed so as to prevent unexpected slipping out of the cellular phone. In particular, due to the above features, an additional cover is not needed for the case for a cellular phone according to the present invention.

As described above, in the case for a cellular phone according to the present invention, an external impact is absorbed. Also, without a cover or an additional locking apparatus, a cellular phone does not easily slip out so that a case for a cellular phone having a low possibility of losing can be provided. Further, when the surface of the cellular phone is contaminated, the surface of the cellular phone is cleaned by simple actions of inserting and taking out the cellular phone with respect to the case.

What is claimed is:

1. A case for a cellular phone comprising an elastic member having corrugated protrusions which is attached to an inner side of the case.

2. The case as claimed in claim 1, Wherein the corrugated protrusions are formed on both inner sides of the case facing each other.

3. The case as claimed in either claim 2, wherein the corrugated protrusions are formed vertically with respect to a direction in which the cellular phone is inserted.

4. The case as claimed in either claim 2, wherein the corrugated protrusions are formed horizontally with respect to a direction in which the cellular phone is inserted.

5. The case as claimed in either claim 2, wherein the corrugated protrusions are formed vertically with respect to a direction in which the cellular phone is inserted, and corrugated grooves are formed horizontally at an interval corresponding to a distance between two pitches of the corrugated protrusions.

6. The case as claimed in claim 4, wherein the corrugated protrusions are formed in sawtooth form with respect to the direction in which the cellular phone is inserted, so that the cellular phone is easily inserted but does not easily slip out.

7. The case as claimed in either claim 2, wherein the elastic member is made of EVA (ethylene vinyl acetate).

8. The case as claimed in either claim 2, wherein the elastic member is made of PU (polyurethane).

9. The case as claimed in either claim 2, wherein the elastic member is sponge.
